(19) United States
(12) Patent Application Publication
(10) Pub. No.: US 2005/0252329 A1
(43) Pub. Date: Nov. 17, 2005

(54) Haptic mechanism

(76) Inventor: Jean-Guy Demers, Montreal (CA)

Correspondence Address: OGILVY RENAULT LLP, 1981 MCGILL COLLEGE AVENUE, SUITE 1600, MONTREAL, QC, H3A2Y3, CA

(21) Appl. No.: 10/844,434

(22) Filed: May 13, 2004

(51) Int. Cl. G05G 1/04

(52) U.S. Cl. 74/471 XY

(57) ABSTRACT

The present invention provides a parallel mechanism comprising a base, three rotary motors fixed on the base, each of the rotary motors having a rotating shaft, three branches, each of the branches having a first end and a second end, the first end of each of the branches being connected to the rotating shaft of a different one of the rotary motors, a central coupler connected to the second end of all of the branches, the branches constraining the central coupler to be movable along at least three degrees of freedom as a function of actuation from any one of the three rotary motors, and at least one counterweight for each of the branches to balance the same about at least the rotating shaft of the corresponding one of the rotary motors such that the central coupler holds a current position and orientation without assistance from the rotary motors.

### BACKGROUND OF THE INVENTION

1. Field of the Invention

The present invention relates to force feedback hand controllers, particularly to three to six degree of freedom hand controllers with rotational handles.

2. Background Art

Force-reflecting master hand controllers fall under two main categories, namely serial mechanisms and parallel mechanisms, and can also be a combination of both in the case of hybrid constructions.

Serial mechanisms or linkages comprise a series of generally rigid links that are joined end-to-end in series. They form a structure analogous to a human arm, with a shoulder supporting an upper arm, which supports a lower arm, which in turn supports a hand. The hand is termed a distal stage, and supports a handle that the user may grasp to move the mechanism. The shoulder is normally mounted to a fixed base. Motors connected to the joints in the linkages serve to apply force and/or torque to the handle.

Serial mechanisms offer a large range of motion, but the joints closer to the motors must support the outer ones. Thus the inner joints require larger motors, which must move the load of the outer joints with their attendant high inertia. Moreover, all joints must be actuated, so either the weight of the joint motors is added to the weight of the links, or the mechanism is made more complex by the use of tendons or other means of transmitting torque to the joints from motors at the base.

Parallel mechanisms comprise two or more branches of linkages that are connected together. One end of each branch is connected to a base, while the other end is connected to a central joint. The central joint may support a handle that a user may grasp to move the mechanism. The motors generally reside in the base, moving the lower links in each branch and working together to apply force or torque to the handle. Because motors are generally not in the moving linkages, the load on the motors in the base consists mainly of lightweight linkages and joints. The weight of the structure and the attendant inertia is thus reduced compared to a serial mechanism. Smaller motors can therefore be employed to give adequate force and/or torque to the handle. However, the range of motion of a parallel mechanism is less than that of a serial mechanism. Moreover, the kinematic solution, the algorithm which relates the position of the central joint to the angles at the base of each branch, is generally more complex than that of a serial structure.

U.S. Pat. No. 5,847,528 discloses a three-degree of freedom parallel mechanism that provides position control of a member in space. The mechanism consists of three branches, each one comprising two link members serially connected together by rotary joints. Three rotary motors in the base drive the lower link of each branch, each of which is rigidly connected to a motor shaft. However, this mechanism does not employ a balanced design, so its load capability is limited since the motors have to counteract significant gravitational forces to hold a given position. In addition, the geometry of the branches produces a mechanism that is relatively voluminous.

U.S. Pat. No. 4,806,068 discloses a three-degree of freedom parallel mechanism also consisting of three branches each with two links serially connected together by rotary joints. The lower links, i.e. the links closer to the base, are translated in one degree of freedom rather than rotated.

U.S. Pat. No. 5,301,566 discloses a three-degree of freedom parallel mechanism also with three branches supporting a platform, each branch having a single inextensible link connected to a five-bar linkage in the plane of the base. The five-bar linkage moves the end of each inextensible link in two-degree of freedom motion in the plane of the base, so that the platform is moved in space.

U.S. Pat. No. 4,651,589 discloses a six-degree of freedom parallel mechanism with three branches supporting a platform. Each branch has two extensible links connected at one end to spherical joints at the platform, and at the other end by a spherical joint to a lower rigid link. The other end of the lower rigid link of each branch is connected to a rotary actuator at the base. A three-degree of freedom mechanism results when the two extensible links in each branch are replaced by inextensible links.

U.S. Pat. No. 4,976,582 discloses a three-degree of freedom parallel mechanism with three branches supporting a platform. Each branch has a four-bar mechanism connected at one end to two spherical joints at the platform, and at the other end by a rotary joint to a rigid lower link. The other end of the lower link of each branch is connected to a rotary actuator at the base. When the platform is moved, it maintains a constant orientation.

U.S. Pat. No. 5,271,290 discloses a six-degree of freedom mechanism with six branches supporting a platform. The branches are arranged in pairs, so that each pair forms a five-bar mechanism to control the 2-degree of freedom position of one corner of a triangular platform, thus controlling the orientation and position of the whole platform.

Accordingly, there is a need for a hand controller allowing at least three-degree of freedom control with a balanced and compact geometry and having a computable forward kinematic model.

### SUMMARY OF INVENTION

It is therefore an aim of the present invention to provide an improved hand controller allowing at least three-degree of freedom control.

It is also an aim of the present invention to provide a balanced hand controller able to hold a current position without assistance.

It is a further aim of the present invention to provide a hand controller with a compact geometry having a readily computable forward kinematic model.

Therefore, in accordance with the present invention, there is provided a parallel mechanism comprising a base, three rotary motors fixed on the base, each of the rotary motors having a rotating shaft, three branches, each of the branches having a first end and a second end, the first end of each of the branches being connected to the rotating shaft of a different one of the rotary motors, a central coupler connected to the second end of all of the branches, the branches constraining the central coupler to be movable along at least three degrees of freedom as a function of actuation from any one of the three rotary motors, and at least one counterweight for each of the branches to balance the same about at least the rotating shaft of the corresponding one of the rotary motors such that the central coupler holds a current position and orientation without assistance from the rotary motors.

Also in accordance with the present invention, there is provided a mechanism for transmitting a motion having at least three degrees of freedom to a processing system, the mechanism comprising a base, three branches, each of the branches including a parallelogram formed by first, second, third and fourth links joined by revolute joints with the first and fourth links being parallel to one another and the second and third links being parallel to one another, each of the branches also including a fifth link rotationally and axially connected to the fourth link, the fifth link being rotationally connected to the base, a sensor coupled to each of the branches and connected to the processing system, and a central coupler rotationally connected to the first link of each of the branches, the branches constraining the central coupler to be movable along the at least three degrees of freedom, an orientation of each one of the branches being measured by the corresponding sensor to produce data used by the processing system to calculate a position and orientation of the central coupler.

In a preferred embodiment, the invention provides a mechanism for moving a member in space. The mechanism comprises three identical branches, each provided with at least first, second, third, four and fifth link members. The three branches are mutually coupled through a central spherical joint. The central joint consists of a payload member with three revolute joints with orthogonal axes. A handle may be attached to the payload member, such that a user may grasp it to manipulate the mechanism. Alternatively, the handle may support an orientation/plunger device with two degrees of freedom in orientation and one degree of freedom of linear motion.

The first link member of each branch is connected to the central spherical joint by means of one of the three revolute joints of the central joint. The first, second, third and fourth link members of each branch form a parallelogram linkage, or a four-bar mechanism, so that the first link is constrained to move parallel to the fourth link. The fourth link has an extension that is connected to a fifth link by an axially revolute joint. The fifth link is connected to the end of a revolute motor shaft positioned normal to the midpoint of the fifth link. Thus, the motor shaft, the fourth link and the fifth link form a spherical joint, which is the base spherical joint for each branch. The three motors are fixedly attached to a common base. Thus three motors connected to the ends of the three branches serve to position the payload relative to the fixed base.

Revolute sensors are attached to one or more of the revolute joints in order to measure the angle of the joint, which is joined to the position of the payload by a kinematics calculation.

The second and fourth links of each branch may have extensions outside the four-bar that hold counterweights, so that the payload and the links comprising the four-bar are balanced in the presence of gravity. Heavy counterweights are used near the axis of movement of the base, in order to minimize inertia.

The payload at the central spherical joint may itself have a one, two or three degree of freedom handle, each joint of which may be sensed by revolute sensors or driven by motors. The motors may be carried on the handle or installed in the fixed base and connected to the handle by flexible means such as belts or tendons.

### BRIEF DESCRIPTION OF THE DRAWINGS

Reference will now be made to the accompanying drawings, showing by way of illustration a preferred embodiment of the present invention and in which:

FIG. 1 is a perspective view of a manipulator in accordance with a preferred embodiment of the present invention;

FIG. 2 is a perspective view of a branch of the manipulator of FIG. 1;

FIG. 3 is a second perspective view of a branch of the manipulator of FIG. 1, emphasizing details around the motor;

FIG. 4 is a perspective schematic view of the three motors of the manipulator of FIG. 1 in position to each support a branch according to FIG. 3;

FIG. 5 is a perspective schematic view of a central joint of the manipulator of FIG. 1 connected to a first handle;

FIG. 6 is a second perspective schematic view of the central joint connected to an alternative three-degree of freedom handle; and

FIG. 7 is a schematic representation of a processing system used with the manipulator of FIG. 1.

### DESCRIPTION OF THE PREFERRED EMBODIMENTS

The present invention falls under the class of hybrid controllers, with a parallel mechanism supporting a serial handle mechanism. The serial handle mechanism may include motors which are generally lightweight. The controller has a balanced design, which permits the motors to apply all their power to the handle mechanism, rather than consuming energy to overcome an unbalanced gravitational load. The present invention makes use of an arrangement of the links that forms a cube in its home position. It therefore has the advantage of being amenable to a relatively simple kinematic approximate solution for three-degree of freedom control.

The mechanism of the present invention in connection with a computer allows for a user to move the handle mechanism to activate, for example, a virtual probe in a synchronous motion. The mechanism can produce a feedback force on the handle mechanism to be reflected to the user's hand when the virtual probe comes in contact with an obstacle.

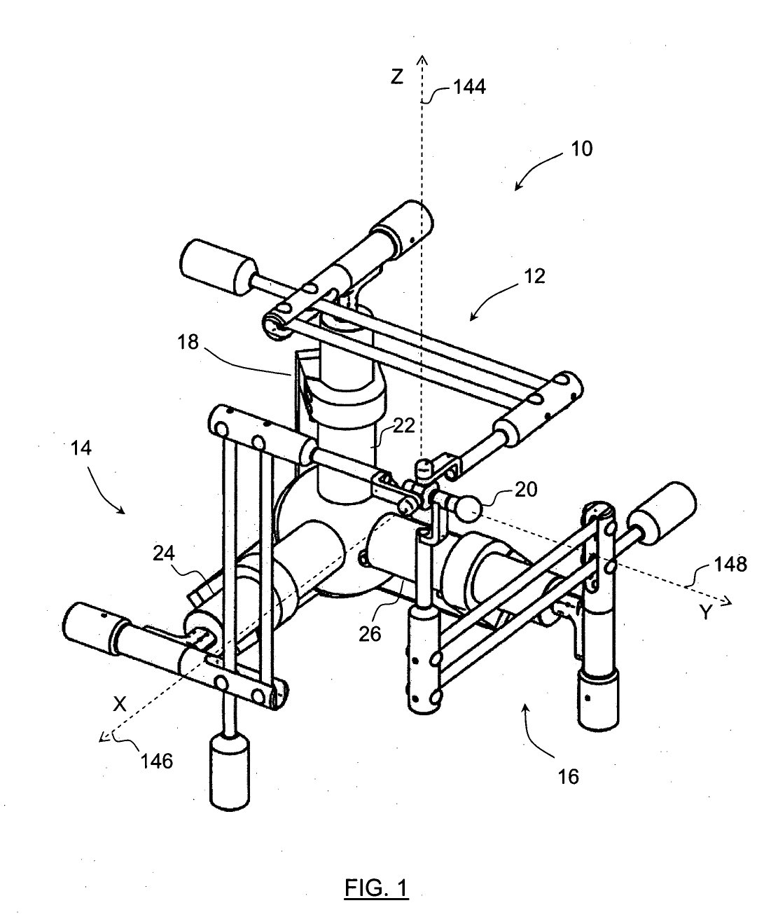

Referring to FIG. 1, a balanced parallel structure for haptic interface according to the present invention is generally shown at 10. The mechanism 10 generally consists of three branches 12,14,16 mounted on a base 18, and connected in parallel to a central joint 20. For ease of reference, the three branches 12,14,16 are arbitrarily labeled “upper”, “left” and “right”, respectively, with reference to an observer who is looking at the mechanism 10 with the central joint 20 closest to the observer. The side of the mechanism 10 that is closest to the observer is labeled “front side”, while the side of mechanism 10 that is farthest from the observer is labeled “back side”.

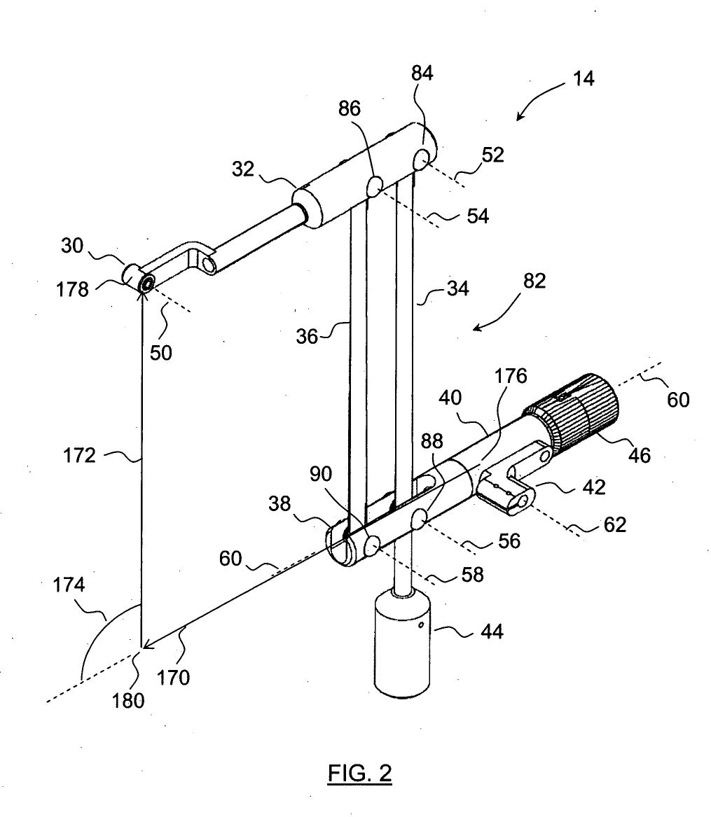

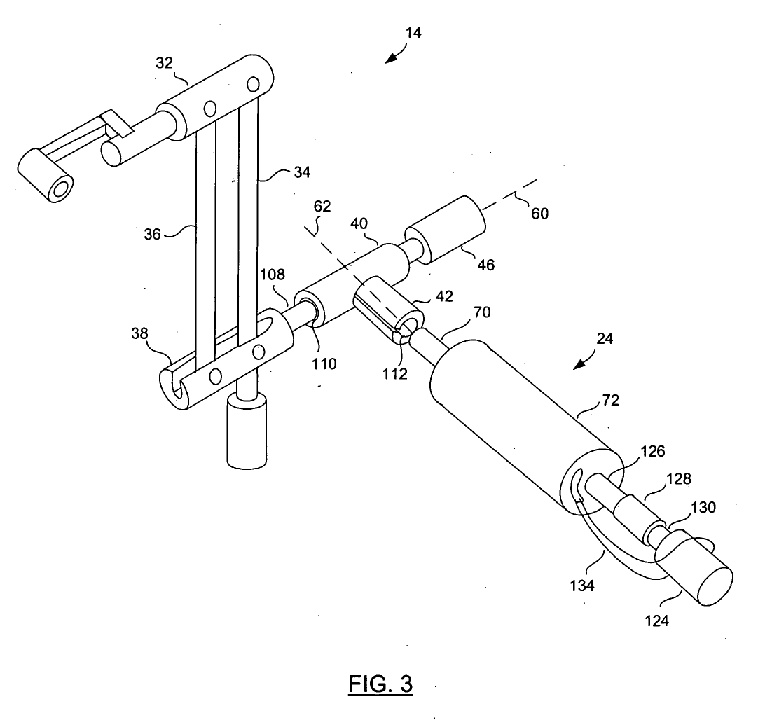

Referring to FIGS. 2-3, the left branch 14 is shown in more details. As the three branches 12,14,16 are of identical construction, only the left branch 14 will be described herein. The reference numerals of the described elements of the left branch 14 will be used to refer to the corresponding elements of any of the branches 12,14,16 throughout the present specification.

The branch 14 comprises a first link 32, a second link 34, a third link 36, a fourth link 38 and a fifth link 40. The first and fourth links 32,38 form the short sides of a parallelogram linkage 82, while the second and third links 34,36 form the long sides of that parallelogram linkage 82. The links 32,34,36,38 forming the parallelogram linkage 82 are connected through revolute joints 84,86,88,90 to allow the links to move in the plane of the parallelogram 82. The four revolute joints 84,86,88,90 each have a respective axis of rotation 52,54,56,58, with the four axes of rotation 52,54,56,58 being mutually parallel and normal to the plane formed by the parallelogram 82. Thus, as the links or sides 32,34,36,38 of the parallelogram linkage 82 move, the first link 32 remains parallel to the fourth link 38, and the second link 34 remains parallel to the third link 36.

The first link 32 extends past the parallelogram 82 toward the front of the mechanism 10. On the front extremity of the first link 32, a central joint hole 30 is defined for receiving a revolute joint having an axis of rotation 50 parallel to axes 52,54,56,58 of the parallelogram 82.

The fourth link 38 extends past the parallelogram 82 toward the back of the mechanism 10. The fifth link 40 has a hole 110 along its length, as shown in FIG. 3. The extension of the fourth link 38 forms a shaft 108 having a smaller diameter section than the longitudinal hole 110 of the fifth link 40, such that the shaft 108 is engaged in that hole 110. A longitudinal revolute joint is thus formed between the fourth link 38 and the fifth link 40, with an axis of rotation 60 collinear with the longitudinal axes of the fourth and fifth links 38,40.

A clamp 42 is fixedly attached to the outside of the fifth link 40 and includes a hole 112 defining an axis of rotation 62 perpendicular to the axis of rotation 60 of the fourth and fifth links 38,40. The hole 112 is designed to receive a motor shaft 70, as shown in FIG. 3. Thus two axes intersect in the fifth link 40, namely the axis of rotation 62 parallel to the motor shaft 70, and the axis 60 parallel to the longitudinal axis of the fourth and fifth links 38,40. The motor shaft 70 is connected to a body 72 of a motor 24.

The motor 24 comprises a reverse extension shaft 126, which protrudes from a back end of the motor body 72. A rotational sensor 124 is coupled to the reverse extension shaft 126 by a cylindrical coupler 128 with holes in both ends. The hole on the front end of the coupler 128 receives the reverse extension shaft 126 of the motor, while the hole on the back of the coupler 128 receives a shaft 130 of the sensor 124. Thus the reverse extension shaft 126 and the shaft 130 of the sensor are axially connected by the coupler 128 and rotate together, the rotation of the sensor shaft 130 accurately measuring the rotation of the reverse extension motor shaft 126. Since the reverse motor shaft 126 is rigidly attached to the motor shaft 70 through the motor body 72, and collinear with the motor shaft 70, the sensor 124 accurately measures the rotation of the motor shaft 70, and hence of the fifth link 40 attached to the shaft 70 by the clamp 42.

The fourth link 38 extends past the fifth link 40 to support a counterweight 46. The counterweight 46 is screwed onto the end of the fourth link 38, and may be adjusted by turning the counterweight 46 until the branch 14 is balanced in gravity when turning about the axis of rotation 62 of the clamp 42.

Likewise, the second link 34 extends past the revolute joint 88 connecting it to the fourth link 38. The extension of the second link 34 supports a counterweight 44, which is screwed onto the end of the second link 34, and may be adjusted by turning the counterweight 44 until the branch 14 is balanced in gravity when turning about the axis of rotation 56 of the joint 88. Alternatively, each of the counterweights 44,46 can be connected to the respective link 34,38 by inserting the link into a central bore of the counterweight, and tightening a set screw inserted through the counterweight perpendicularly to the hole to press against the link. It is to be understood that a number of other equivalent means to connect each of the counterweights 44,46 to the respective link 34,38 can also be used.

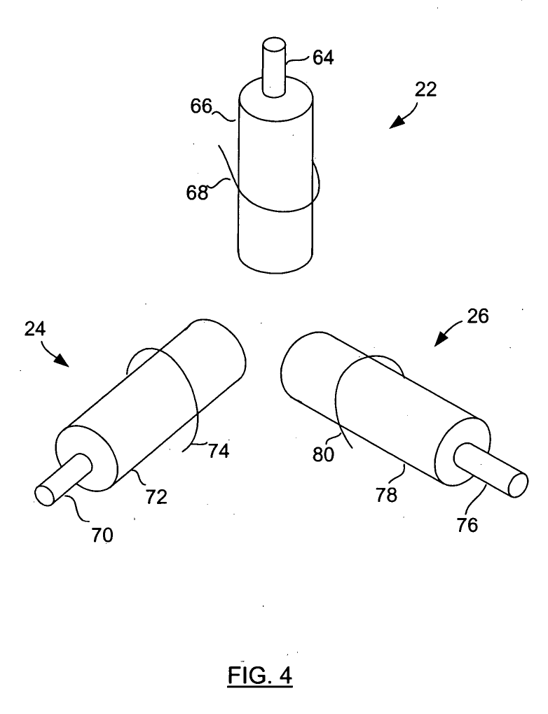

Referring to FIG. 4, the upper, left, and right rotary motors 22,24,26 are placed at right angles to one another, along three edges of an imaginary cube. For clarity, different reference numerals have been assigned for like elements of different motors. Thus, the upper motor 22 includes a motor shaft 64 and a motor body 66, and the right motor 26 includes a motor shaft 76 and a motor body 78. The three motors 22,24,26 are fixedly attached to the base 18 (see FIG. 1) by the use of clamps 68,74,80 around the motor bodies 66,72,78, respectively. The motor shaft 64 of the upper motor 22 is pointing upward, the motor shaft 70 of the left motor 24 is pointing to the left, and the motor shaft 76 of the right motor 26 is pointing to the right. The motor shafts 64,70,76 are fixedly attached to the fifth link 40 of the corresponding branch 12,14,16 by means of the clamp 42 in each branch, as explained above.

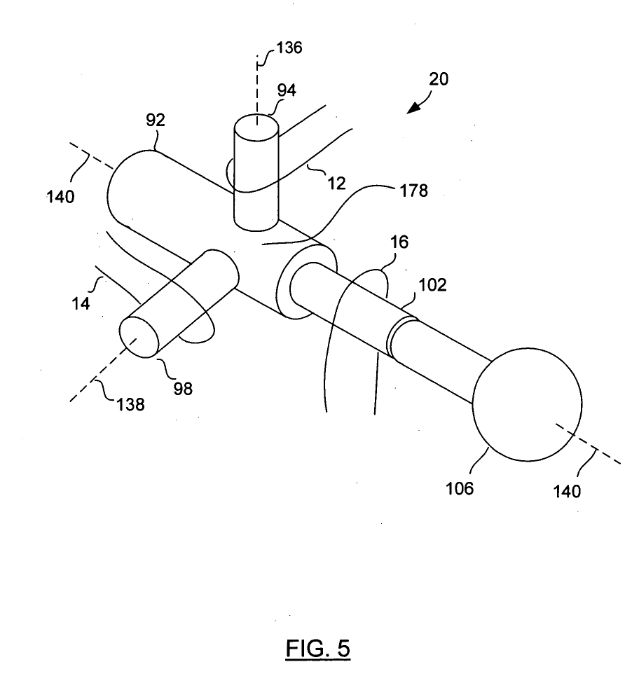

The first links 32 of the three branches 12,14,16 are each attached by revolute joints to the central joint 20 (see FIGS. 1-2). Referring to FIG. 5, where the location of the branches 12,14,16 is only schematically represented, the central joint 20 has a body 92 supporting mutually orthogonal upper, left and right shafts 94,98,102. The central joint upper shaft 94 is received in the central joint hole 30 in the first link 32 of the upper branch 12. Similarly, the central joint left shaft 98 is received in the central joint hole 30 in the first link 32 of the left branch 14, and the central joint right shaft 102 is received in the central joint hole 30 in the first link 32 of the right branch 16. The upper, left and right central joint shafts 94,98,102 each define a respective axis of rotation 136,138,140.

Because the axis of rotation 50 of the central joint hole 30 in each branch 12,14,16 is parallel to the axes of rotation 52,54,56,58 of the parallelogram 82 of that branch (see FIG. 2), each branch moves the central joint 20 in the plane of that parallelogram 82. Thus, as seen in FIGS. 2 and 5, the central joint 20 rotates about the axis 136 of the central joint upper shaft 94 in response to the movement of the upper branch 12, and the axis 136 remains coincident with the axis 50 of the central joint hole 30 of the upper branch 12 similarly, the central joint 20 rotates about the axis 138 of the central joint left shaft 98 in response to the movement of the left branch 14, and about the axis 140 of the central joint right shaft 102 in response to the movement of the right branch 16. As the central joint 20 moves in translation, it takes a range of angles in response to the movements of the branches 12,14,16.

A spherical handle 106 is fixedly attached to the body 92 of the central joint 20. The handle 106, the central joint body 92 and the central joint right shaft 102 share the axis 140 of the right shaft 102. Thus the orientation of the axis 140 of the right shaft 102, and of the central joint body 92, is determined by the orientation of the right branch 16. This is because the central joint hole 30 of the right branch 16 receives the right shaft 102 of the central joint 20, making the axis 140 of the right shaft 102 and the axis 50 of the right branch 16 coincident, and because the right shaft 102 is fixedly attached to the central joint body 92.

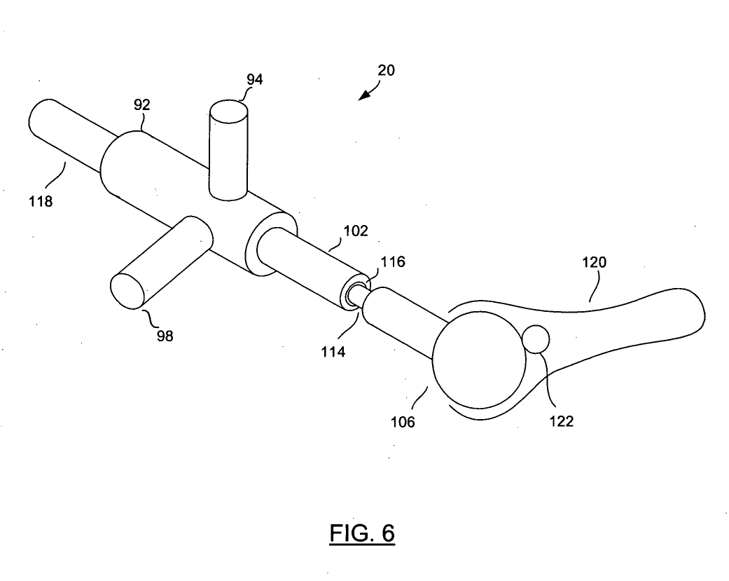

The mechanism 10 in the configuration described provides a three-degree of freedom motion. It is also considered to include a distal stage that provides two degrees of freedom of rotational motion, and possibly one degree of freedom in a linear motion. In an alternative embodiment, and as shown in FIG. 6, a handle with rotation 120 is installed over the spherical form of the handle 106 of the previous embodiment. The rotation of the handle 120 is instrumented to detect its angle, for example by the rotation of a sensor wheel 122 pressed against the spherical form 106. It is also considered to drive the wheel 122 by a motor internal to the handle 120, or by motors fixedly mounted to the base 18 and linked to the handle 120 by tendons carried on pulleys mounted on one or more of the branches 12,14,16.

It is also considered to install the handle with rotation 120 or the spherical handle 106 so that the handle can slide or rotate in the central joint body 92. A longitudinal hole 116 is defined in the central joint body 92. A shaft 114 having an appropriate diameter is inserted in the longitudinal hole 116 through the body 92 and emerges on the other side to define an extension shaft 118. The spherical form 106, the shaft 114 and the extension shaft 118 are aligned and fixedly attached to one another. The sliding motion of the extension shaft 118 in the central joint body 92 is preferably instrumented with a linear sensor mounted on the central joint body 92. It is also considered to drive the sliding motion by a linear motor mounted on the central joint body 92. Similarly, the rotating motion of the extension shaft 118 in the central joint body 92 is preferably instrumented with a rotary sensor and driven by a rotary motor, both of which being mounted on the central joint body 92.

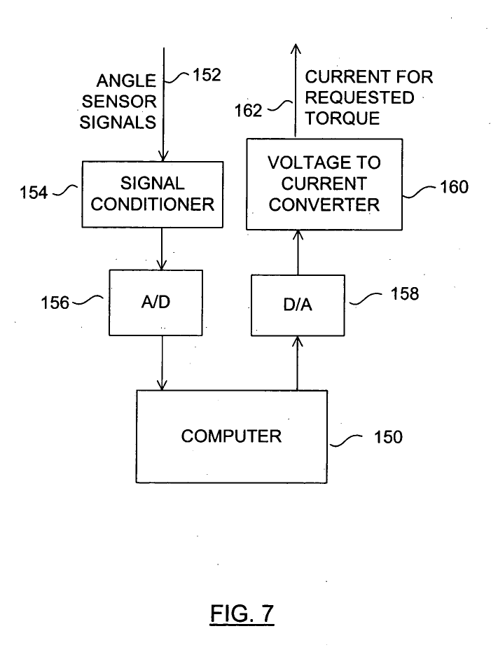

In operation, the user grasps the handle 106 (or 120) and moves it. Movements of the handle 106, 120 are measured by the rotational sensors 124 attached to the motors 22, 24 and 26 at the base of each branch 12, 14, 16. FIG. 7 shows a processing system preferably used with the mechanism 10. The voltages representing angle sensor signals 152 of the sensors 124 are passed to a computer 150 through a signal conditioner 154 and an analogue to digital converter 156. In the signal conditioner 154, the signals 152 are amplified to the full voltage range of the A/D converter 156 and filtered with a 100 Hz low pass filter to remove noise.

In a preferred embodiment, a program in the computer 150 accepts the angle measurements 152 and moves a virtual probe synchronously with the motion of the mechanism 10. If desired, the computer program computes the required force to be reflected to the user's hand, when, for example, the virtual probe touches a virtual surface. The program uses kinematics algorithms to convert this required force to a required motor torque, then to a voltage known to produce that torque which is fed to a digital to analogue converter 158. The output of the D/A converter 158 is fed to a voltage to current converter 160 connected to the motors 22,24,26. The current applied to motors 22,24,26 then produces the required torque.

The various elements of the mechanism 10 are preferably machined from solid aluminum, except for the second and third links 34,36 of the branches 12,14,16 which are preferably round steel shafts. Flanged bearings are preferably inserted on both sides of each joint, and preloaded by tensioning with holding screws, with the screw heads pressing on the inner race of the bearing and the flange of the bearing resting on the outside of the hole.

In a preferred embodiment, the motors 22,24,26 are 90-Watt motors from Maxon, Model RE035-071-34EAB200A. The D/A converter 158 is a PCI-6208 converter from Adlink, while the voltage to current converter 160 for each motor is a model PA12A converter from Apex. The rotational sensors 124 are magneto-resistance sensors from Midori America Corporation, Model CP-2UTX. The A/D converter 156 for each sensor is a KPCI-3107 converter from Keithley.

The kinematics algorithm of the mechanism 10 is relatively simple, because of its symmetrical construction. Although several solutions, varying in complexity and precision, can be used to characterize the motion and torque of the central joint 20, a solution is possible when the angular sensors are located at the elbow (as will be described hereinafter). This solution is simple and straightforward, and will be described in the following. The mechanism 10 as represented in FIG. 1 is shown in its “home position”, in which the parallelogram 82 of each branch 12,14,16 forms a rectangle with right angle corners. A Cartesian coordinate system is defined with its origin at the home position, with a positive y-axis 148 coincident with the axis 140 of the central joint right shaft 102 (i.e. the axis going through the handle 106), a positive x-axis 146 coincident the axis 138 of the central joint left shaft 98, and a positive z-axis 144 coincident with the axis 136 of the central joint upper shaft 94. Thus x, y and z form a right-handed system with its origin at the home position of the central joint.

Since the mechanism 10 nominally takes the general form of a cube in its home position, this allows some simple kinematic equations to be defined. For example, suppose L is the length of the side of the nominal cube. Referring to FIGS. 2 and 5, at home position, L is equal to the y-component of the distance from a “motor point” 176 located at the intersection of the axis of rotation 60 of the fourth link 38 and the axis of rotation 62 of the clamp 42 of branch 14, to a “central point” 178, defined as the intersection of axes 136, 138 and 140 of the central joint 20. L is also equal to the z-component of the distance from the motor point 176 to the central point 178. By symmetry, each side of the nominal cube at home position has the same length L.

The location of the central point 178 at home position is coincident with the origin of the coordinate system 144, 146 and 148. We will refer to this fixed location as the “origin”, while the central point 178 may move relative to the origin.

In terms of the coordinate system 144, 146, 148, the positions of the motor points 176 of each branch 12, 14 and 16 are given, respectively, by
M₀=(0,−L,−L)
M₁=(−L,0,−L)
M₂=(−L,−L,0)
where subscripts 0, 1 and 2 represent branches 14, 16 and 12, respectively. The vector quantities Mi will be referred to as “motor vectors”. These are vector that do not move as the mechanism moves, each one being a vector from the origin to a motor point.

Now define biceps vectors 170 and forearm vectors 172, termed, respectively, Bᵢ and Gᵢ for branch i, where i may be 0, 1 or 2 to represent branch 12, 14 or 16. As seen in FIG. 2, the biceps vector 170 is defined from the motor point 176 of each branch to an elbow point 180, in a direction parallel to axis 60 of the fourth link 38 of each branch. The length of the vector 170 is L, defining the position of the elbow point 180. The forearm vector 172 is drawn from the elbow point 180 in a direction parallel to third and fourth links 36 and 38, with a length L. Because of the four-bar mechanism, parallelogram linkage 82, in each branch, the forearm vector reaches from the elbow point 180 to the central point 178.

Define also φᵢ, the angle 174 between the biceps vector 170 and the forearm vector 172, according to the usual definition for angles between vectors (so that the dot product of the vectors equals the cosine of the angle between them). For convenience, we also define αᵢ, the complement of the angle φᵢ, (that is, αᵢ=π/2−φᵢ).

Define also a vector X drawn from the origin (the central point 178 at home position) to the location in space of the central point 178 when it is moved from home position by the action of the mechanism 10.

Because of the geometry of mechanism 10, vector X is equal to the sum of the vectors from the origin (central point 178 at home position), through the motor point 176 and the elbow point 180:
Mᵢ+Bᵢ+Gᵢ=X
Rearranging this equation, we put Bᵢ and Gᵢ on the left:
Bᵢ+Gᵢ=X−Mᵢ
Squaring both sides,
Bᵢ²+2 Bᵢ·Gᵢ+Gᵢ²=X²−2 X·Mᵢ+Mᵢ²
Vectors Bi and Gi each have length L, while vectors Mi have length L from the definition of Mi:
Bᵢ²=L²
Gᵢ²=L²
Mᵢ²=2L²
Bᵢ·Gᵢ=L² cos φᵢ
Substituting these into the squared equation,
L²+2 L² cos φᵢ+L²−2 X·Mᵢ+2L²
which may be rearranged to give,
cos φᵢ=L⁻²(X²/2−X·Mᵢ)
Using αᵢ, the complement of angle φᵢ, we get
sin αᵢ=L⁻²(X²/2−X·Mᵢ)
Explicitly, for each branch,
S₀≡sin α₀=L⁻²((X₀²+X₁²+X₂²)/2+L(X₁+X₂))
S₁≡sin α₁=L⁻²((X₀²+X₁²+X₂²)/2+L(X₀+X₂))
S₂≡sin α₂=L⁻²((X₀²+X₁²+X₂²)/2+L(X₀+X₁))
This gives the inverse kinematics, in which the joint angles are derived from the central joint position in space. The forward kinematics may be derived by inversion of these equations to obtain the symmetric set of equations,
Xᵢ=−L(K+Sᵢ)
for each i, where
K=⅓[2−(S₀+S₁+S₂)−√2[2+(S₀+S₁+S₂)−(S₀²+S₁²+S₂²)+S₀S₁+S₀S₂+S₁S₂]^{1/2}]

Although the mechanism 10 has been described as being actuated, such as to produce a motion on the handle, it is understood that the mechanism 10 can be used to merely capture and transmit the movements of the handle to the processing system. In that case, the motors can be omitted and the fifth link of each branch is rotationally received on the base, with a rotational sensor being provided for each branch, for example at the fifth link.

The mechanism of the present invention presents several advantages. The parallel nature of the mechanism allows fast response, with direct connection of the links to the motors. The mechanism is highly responsive to the driving torque applied by the motors, thus making possible the rendering of higher virtual stiffness.

The motors 22, 24 and 26 are fixedly mounted to the base 18, so their weight does not have to be carried in the structure of the mechanism. The mechanism thus has low inertia and can be moved rapidly.

In the case in which the rotational sensors 124 are mounted to the motor bodies 66,72,78, the sensors can be rotated into their correct position simply by turning the motor body to which that sensor is attached. It is pointed out that angular displacements may be measured at any suitable location (e.g., joints) on the mechanism 10.

Preloaded bearings in each joint allow response with reduced backlash and a minimum of friction. The design is simple, and can be built efficiently.

By making use of magneto-resistance effect sensors connected to a 16-bit analog to digital converter, the mechanism can deliver an angular resolution of some 7 seconds of arc over a 120 degree range of motion, without the weight, size and expense penalties incurred by optical encoders.

Because of the counterweights, the mechanism 10 is balanced in a gravitational field. Accordingly, the central coupler can maintain any position without assistance when no motion is transmitted by the handle. This reduces the load on the motors, which can put their energy into positioning rather than holding a position.

The mechanism, 10, because of the “cubic” configuration, allows near-separation of variables, so that each branch is generally responsible for motion in one of the three Cartesian directions.

The embodiments of the invention described above are intended to be exemplary. Those skilled in the art will therefore appreciate that the foregoing description is illustrative only, and that various alternatives and modifications can be devised without departing from the spirit of the present invention. Accordingly, the present is intended to embrace all such alternatives, modifications and variances which fall within the scope of the appended claims.

1. A parallel mechanism comprising:
a base;
three rotary motors fixed on the base, each of the rotary motors having a rotating shaft;
three branches, each of the branches having a first end and a second end, the first end of each of the branches being connected to the rotating shaft of a different one of the rotary motors;
a central coupler connected to the second end of all of the branches, the branches constraining the central coupler to be movable along three degrees of freedom as a function of actuation from any of the three rotary motors; and
at least one counterweight for each of the branches to balance the branches about at least the rotating shaft of the corresponding one of the rotary motors such that the central coupler holds a current position and orientation without assistance from the rotary motors.

2. The parallel mechanism according to claim 1, wherein the rotating shaft of each of the rotary motors is orthogonal to the rotating shaft of the other two rotary motors.

3. The parallel mechanism according to claim 1, wherein each of the branches includes first, second, third and fourth links joined by revolute joints to form a parallelogram with the first and fourth links being parallel to one another and the second and third links being parallel to one another.

4. The parallel mechanism according to claim 3, wherein the branches can be arranged in a home position where the parallelogram of each of the branches is orthogonal to the parallelogram of the other two branches.

5. The parallel mechanism according to claim 4, wherein in each of the branches the first link extends from the parallelogram to form the second end pivotally connected to the central coupler about an axis perpendicular to the first link, the fourth link extends from the parallelogram to be rotationally and coaxially connected to a fifth link, and the fifth link forms the first end perpendicularly fixed to the rotating shaft of the corresponding motor.

6. The parallel mechanism according to claim 5, wherein the fourth link extends past the fifth link to receive one of the at least one counterweight.

7. The parallel mechanism according to claim 3, wherein the at least one counterweight also balances the corresponding one of the branches about one of the revolute joints of the parallelogram.

8. The parallel mechanism according to claim 5, wherein the second link extends past the fourth link to receive one of the at least one counterweight to balance the branch about one of the revolute joints of the parallelogram.

9. The parallel mechanism according to claim 1, wherein the central coupler is connected to a handle adapted to be manipulated by a user.

10. The parallel mechanism according to claim 9, wherein the handle is connected to the central coupler to be rotatable along two degrees of freedom, the handle comprising a sensor to detect a rotation thereof and means for imparting a torque on the handle.

11. The parallel mechanism according to claim 9, wherein the handle is connected to the central coupler to be slidable therein, the handle comprising a sensor to detect a sliding motion thereof and means for imparting a sliding force on the handle.

12. The parallel mechanism according to claim 1, further comprising a rotational sensor for each of the rotating shafts to transmit data corresponding to an orientation of the rotating shafts to a processing system to calculate the current position and orientation of the central coupler as a function of the data.

13. A mechanism for transmitting a motion to a processing system, the mechanism comprising:
a base;
three branches, each of the branches including a parallelogram formed by first, second, third and fourth links joined by revolute joints with the first and fourth links being parallel to one another and the second and third links being parallel to one another, each of the branches also including a fifth link rotationally and axially connected to the fourth link, the fifth link being rotationally connected to the base;
a sensor coupled to each of the branches and connected to the processing system; and
a central coupler rotationally connected to the first link of each of the branches, the branches constraining the central coupler to be movable along three degrees of freedom, an orientation of each one of the branches being measured by the corresponding sensor to produce data used by the processing system to calculate a position and orientation of the central coupler.

14. The mechanism according to claim 13, wherein for each of the branches the fifth link is rotationally connected to the base through a rotary motor, the rotary motor receiving instructions from the processing system to produce a feedback actuation on the central coupler.

15. The mechanism according to claim 13, wherein for each of the branches the fifth link is connected to the base to rotate about a first axis perpendicular to the fifth link and the first link is connected to the central coupler to rotate about a second axis perpendicular to the first link.

16. The mechanism according to claim 13, wherein each of the branches includes at least one counterweight to balance the same about at least the base such that the central coupler holds a current position and orientation without assistance.

17. The mechanism according to claim 13, wherein the data is an orientation of each of the fifth links with respect to the base.
